(19) United States
(12) Patent Application Publication
(10) Pub. No.: US 2026/0333359 A1
(43) Pub. Date: Oct. 22, 2026

(54) ESTIMATED GAIN REPORTING FOR PRECODING SCHEME INDICATION IN A WIRELESS COMMUNICATION SYSTEM

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US); Jing JIANG, San Diego, CA (US)

(21) Appl. No.: 19/181,998

(22) Filed: Apr. 17, 2025

(51) Int. Cl. H04W 72/21; H04B 7/0456

(52) U.S. Cl. CPC H04W 72/21; H04B 7/0456

(57) ABSTRACT

This disclosure provides methods, components, devices and systems for estimated gain reporting for precoding scheme indication in a wireless communication system. For example, a user equipment (UE) may transmit a message that indicates an estimated gain associated with use of UE-centric precoding for communications by the UE, where the estimated gain is based on measurement of a reference signal received by the UE. The UE may receive an uplink grant that indicates a precoding scheme for a subsequent uplink transmission, the precoding scheme selected, by a network entity, from the UE-centric precoding or codebook-based precoding based on the estimated gain. The UE may transmit the subsequent uplink transmission using the precoding scheme indicated via the uplink grant.

### TECHNICAL FIELD

This disclosure relates generally to wireless communication, and more specifically to systems, devices, methods, and techniques associated with estimated gain reporting for precoding scheme indication in a wireless communication system.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include transmitting a message that indicates an estimated gain associated with use of UE-centric precoding for communications by the UE, where the estimated gain is based on measurement of a reference signal, receiving an uplink grant that indicates a precoding scheme for a subsequent uplink transmission, the precoding scheme including the UE-centric precoding or codebook-based precoding based on the estimated gain, and transmitting, based on the uplink grant and using the precoding scheme indicated via the uplink grant, the subsequent uplink transmission.

A UE for wireless communications is described. The UE may include a processing system that includes processor circuitry and memory circuitry that stores code. The processing system may be configured to cause the UE to transmit a message that indicates an estimated gain associated with use of UE-centric precoding for communications by the UE, where the estimated gain is based on measurement of a reference signal, receive an uplink grant that indicates a precoding scheme for a subsequent uplink transmission, the precoding scheme including the UE-centric precoding or codebook-based precoding based on the estimated gain, and transmit, based on the uplink grant and using the precoding scheme indicated via the uplink grant, the subsequent uplink transmission.

Another UE for wireless communications is described. The UE may include means for transmitting a message that indicates an estimated gain associated with use of UE-centric precoding for communications by the UE, where the estimated gain is based on measurement of a reference signal, means for receiving an uplink grant that indicates a precoding scheme for a subsequent uplink transmission, the precoding scheme including the UE-centric precoding or codebook-based precoding based on the estimated gain, and means for transmitting, based on the uplink grant and using the precoding scheme indicated via the uplink grant, the subsequent uplink transmission.

A non-transitory computer-readable medium storing code for wireless communications is described. The code may include instructions executable by one or more processors to transmit a message that indicates an estimated gain associated with use of UE-centric precoding for communications by the UE, where the estimated gain is based on measurement of a reference signal, receive an uplink grant that indicates a precoding scheme for a subsequent uplink transmission, the precoding scheme including the UE-centric precoding or codebook-based precoding based on the estimated gain, and transmit, based on the uplink grant and using the precoding scheme indicated via the uplink grant, the subsequent uplink transmission.

Some examples of the method, UEs, and non-transitory computer-readable medium described herein may further include operations, features, means, or instructions for receiving a second message that indicates a reference power level associated with the communications by the UE, where the estimated gain includes an estimated power gain associated with the use of the UE-centric precoding for the communications relative to the reference power level.

In some examples of the method, UEs, and non-transitory computer-readable medium described herein, transmitting the message may include operations, features, means, or instructions for transmitting, via the message, an indication of the estimated gain including an estimated performance gain associated with the use of the UE-centric precoding for the communications relative to an estimated performance associated with use of the codebook-based precoding for the communications, where the estimated performance associated with the codebook-based precoding may be based on a reference precoding matrix.

Some examples of the method, UEs, and non-transitory computer-readable medium described herein may further include operations, features, means, or instructions for receiving control signaling that allocates a set of multiple transmission occasions for periodic or semi-persistent gain reporting for one or more ranks, where the message that indicates the estimated gain may be transmitted via at least one transmission occasion of the set of multiple transmission occasions allocated via the control signaling, and where the estimated gain may be associated with the one or more ranks.

Some examples of the method, UEs, and non-transitory computer-readable medium described herein may further include operations, features, means, or instructions for receiving a first uplink grant that indicates first resources associated with the reference signal and second resources associated with the message and receiving the reference signal via the first resources indicated via the first uplink grant, where the estimated gain may be based on measurements of the reference signal received via the first resources, and where the message may be transmitted via the second resources indicated via the first uplink grant.

Some examples of the method, UEs, and non-transitory computer-readable medium described herein may further include operations, features, means, or instructions for receiving a first message that indicates first resources associated with the reference signal, receiving the reference signal via the first resources indicated via the first message, and receiving a second message that indicates second resources associated with the message, where the message may be transmitted via the second resources indicated via the second message.

In some examples of the method, UEs, and non-transitory computer-readable medium described herein, receiving the uplink grant may include operations, features, means, or instructions for receiving, via the uplink grant, a transmit precoding matrix indicator (TPMI) that indicates a quantity of layers associated with the subsequent uplink transmission and a bit that indicates the precoding scheme for the subsequent uplink transmission, where a first value of the bit indicates the precoding scheme includes the UE-centric precoding and a second value of the bit indicates the precoding scheme includes the codebook-based precoding.

In some examples of the method, UEs, and non-transitory computer-readable medium described herein, receiving the uplink grant may include operations, features, means, or instructions for receiving, via the uplink grant, a field that indicates a quantity of layers associated with the subsequent uplink transmission and that indicates the precoding scheme for the subsequent uplink transmission, where a first set of states of the field indicate the precoding scheme includes the UE-centric precoding and a second set of states of the field indicate the precoding scheme includes the codebook-based precoding.

### BRIEF DESCRIPTION OF THE DRAWINGS

FIG. 1 shows an example of a wireless communication system.

FIG. 2 shows an example of a signaling configuration that supports estimated gain reporting for precoding scheme indication in a wireless communication system.

FIG. 3 shows an example of a signaling timeline that supports estimated gain reporting for precoding scheme indication in a wireless communication system.

FIGS. 4A-4C show examples of signaling timelines that support estimated gain reporting for precoding scheme indication in a wireless communication system.

FIG. 5 shows an example of a process flow that supports estimated gain reporting for precoding scheme indication in a wireless communication system.

FIG. 6 shows a block diagram of a processing system that supports estimated gain reporting for precoding scheme indication in a wireless communication system.

FIG. 7 shows a diagram of a system including a device that supports estimated gain reporting for precoding scheme indication in a wireless communication system.

FIG. 8 shows a flowchart illustrating methods that support estimated gain reporting for precoding scheme indication in a wireless communication system.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support various uplink multiple-input-multiple-output (MIMO) modes, such as codebook-based MIMO and non-codebook-based MIMO. While operating according to a codebook-based MIMO mode, a network entity may select a precoding scheme from a defined codebook to be applied by a user equipment (UE). That is, the UE and the network entity may exchange control signaling that indicates or otherwise be configured with a defined codebook of multiple precoding schemes, and the network entity may indicate a precoding scheme by transmitting a transmit precoding matrix indicator (TPMI) that points to one precoding scheme from among the multiple indicated via the defined codebook. While operating according to a non-codebook-based MIMO mode, the UE and the network entity may derive the precoding scheme without being constrained by the defined codebook, which may enable higher-resolution precoding as compared with codebook-based MIMO. However, non-codebook-based MIMO may be associated with increased latency (e.g., due to additional signaling between the network entity and the UE) and increased processing complexity as compared with codebook-based MIMO.

Some wireless communication systems may support UE-centric MIMO to increase precoding resolution while reducing signaling latency and processing complexity, among other examples. While operating according to a UE-centric MIMO mode, the UE and the network entity may derive precoding parameters in parallel based on exchanged reference signals. For example, the network entity may determine a reference modulation and coding scheme (MCS), while the UE may determine (e.g., simultaneously) the precoding scheme to be applied by the UE. The UE may receive an uplink grant indicating the reference MCS and may determine (e.g., calculate) a final MCS to be applied by the UE, along with the precoding scheme. The UE may transmit an uplink transmission by applying the precoding scheme and the final MCS determined by the UE, which may enable relatively high resolution precoding at the UE. However, in some cases, it may be desirable for the network entity to determine (e.g., dynamically) whether the UE applies UE-centric precoding or an alternative precoding technique to subsequent uplink transmissions. Additionally, or alternatively, it may be beneficial for the network entity to determine the final MCS to be used by the UE, regardless of the applied precoding technique.

Aspects of the subject matter described in this disclosure relate to flexible UE-centric precoding that enables a UE and a network entity to determine whether the UE should apply UE-centric precoding or codebook-based precoding based on an estimated gain associated with the UE-centric precoding. For example, the UE may estimate, based on measurements of reference signals received by the UE, an estimated gain provided by use of the UE-centric precoding relative to use of the codebook-based precoding. The UE may report the estimated gain to the network entity. The UE may receive an uplink grant from the network entity that indicates whether the UE is to apply the UE-centric precoding or the codebook-based precoding to subsequent uplink transmissions based on the reported estimated gain. The uplink grant may also indicate the MCS to be applied to the subsequent uplink transmissions, as determined by the network entity. Accordingly, the UE may transmit the subsequent uplink transmissions using the indicated precoding scheme and MCS.

Particular aspects of the subject matter described in this disclosure can be implemented to realize one or more of the following potential advantages. By enabling the UE to report the estimated gain associated with UE-centric precoding relative to codebook-based precoding, the described techniques may enable dynamic indication of a precoding scheme to be applied by the UE based on a performance gain associated with the precoding scheme, which may improve communication reliability, throughput, and coordination between devices. In addition to receiving an indication of the precoding scheme, the UE may also receive an indication of the MCS, which may provide for the network entity to determine the final MCS to be applied by the UE, thereby improving coordination between devices and network management processes, among other examples. Additionally, or alternatively, by performing UE-centric precoding, the network entity and the UE may refrain from using a codebook unless the codebook would provide sufficient gains, which may increase precoding resolution and reduce overhead. Thus, by implementing the aspects of the subject matter in this disclosure, a wireless communication system may realize advantages associated with UE-centric precoding, such as increased resolution, while the network entity determines the final MCS and precoding scheme selection to be applied by the UE.

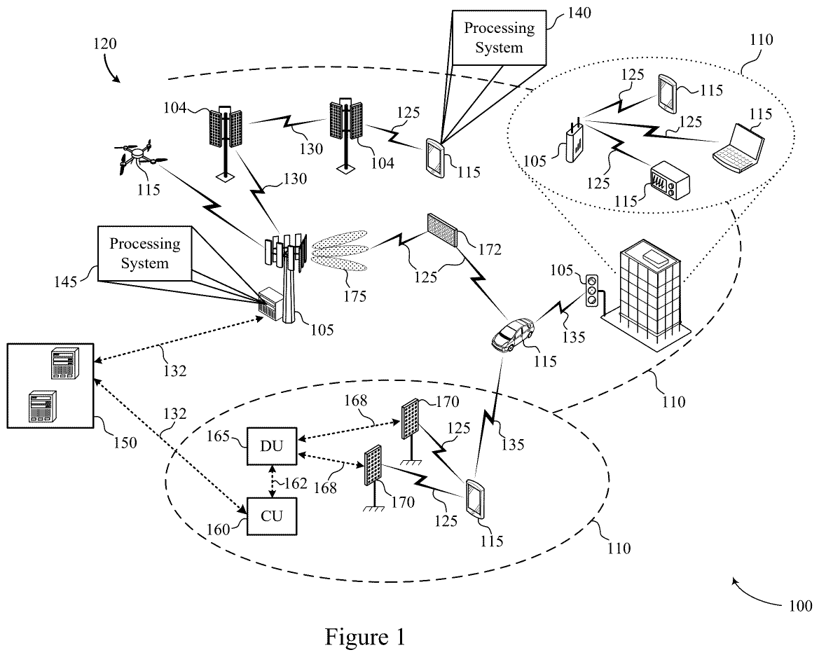

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices in the wireless communication system 100 (such as network entities 105, UEs 115) may modulate and code information prior to transmission of a signal (such as of a physical channel). A MCS may define how modulation and coding is to be performed, which may include an implementation in accordance with a modulation order and a target code rate. A code rate may be achieved using a channel coding scheme such as forward error correction (FEC) (such as to add redundancy). Examples of FEC include block codes, convolutional codes, and linear error-correcting codes. At a receiver (such as to demodulate modulation symbols of a physical channel), a decoder may employ probabilistic or iterative techniques to perform soft decision-making, and code blocks for bit streams may employ a check code (such as a cyclic redundancy check (CRC) code, a low-density parity-check (LDPC)) to detect and correct decoding errors.

Devices of the wireless communication system 100 may be configured to support one or more aspects of the described techniques for estimated gain reporting for precoding scheme indication in a wireless communication system. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support estimated gain reporting for precoding scheme indication to enable higher resolution precoding with reduced latency.

Some wireless communication systems may support various uplink MIMO modes, such as codebook-based MIMO and non-codebook MIMO. While operating according to a codebook-based MIMO mode, a network entity 105 may select a precoding scheme from a predefined codebook to be applied by a UE 115. For example, the network entity 105 may receive a reference signal (e.g., SRS) from a UE 115 and may measure the reference signal to determine the precoding scheme and MCS to be applied to subsequent uplink transmissions. The network entity 105 may indicate the precoding scheme to a UE 115 via an uplink grant including a TPMI and MCS indication. Codebook-based precoding may be associated with reduced latency (e.g., due to a single reference signal being transmitted and measured) relative to non-codebook-based precoding, but may be associated with relatively low resolution, as the network entity 105 may be constrained to selecting the precoding scheme from a set of precoding schemes defined in a codebook. Additionally, while reciprocity is not required for codebook-based MIMO, subband precoding may not be sufficiently supported, and relatively limited flexibility for different antenna architectures may decrease performance associated with codebook-based MIMO.

While operating according to a non-codebook-based MIMO mode, a UE 115 may derive the precoding scheme without being constrained by the defined codebook, which may enable higher-resolution precoding as compared with codebook-based precoding, and relatively flexible precoding (e.g., phase-continuous frequency-selective precoding). However, non-codebook-based MIMO may be associated with increased latency (e.g., due to additional signaling between the network entity and the UE) and increased processing complexity relative to codebook-based precoding. For example, two reference signal measurements (one at the UE 115 and another at the network entity 105) may be performed sequentially in order to derive a UE-centric precoding scheme and an MCS to be applied to subsequent uplink transmissions. Additional processing may performed by the network entity 105 to decode a precoded reference signal transmitted by a UE 115. Further, block-wise subband precoding may not be supported when performing non-codebook-based MIMO.

Accordingly, some wireless communication systems may support UE-centric MIMO to increase precoding resolution while reducing signaling latency and processing complexity. While operating according to a UE-centric MIMO mode, a UE 115 and a network entity 105 may derive precoding parameters in parallel based on exchanged reference signals. For example, the network entity 105 may determine a reference MCS while the UE 115 may determine (e.g., simultaneously) the precoding scheme to be applied. An uplink grant including a TPMI may indicate a rank for subsequent uplink communications, to which the UE 115 may apply a UE-centric precoding scheme that is indicated via the uplink grant, as well as a final MCS, which may be calculated based on a reference MCS and an estimated MCS determined according to a beamforming gain. Thus, UE-centric precoding may enable relatively high resolution precoding while reducing latency associated with a precoding update period associated with determining the precoding scheme.

As described herein, the wireless communication system 100 may support a flexible UE-centric precoding scheme that enables the UE 115 to apply either UE-centric precoding or codebook-based precoding to subsequent uplink transmissions based on an estimated gain (e.g., a signal-to-noise ratio (SNR) gain, a MCS gain, and the like) associated with the UE-centric precoding. The described techniques may thereby provide for the UE 115 and the network entity 105 to account for tradeoffs in performance gain between UE-centric precoding (e.g., non-codebook-based precoding) and codebook-based precoding. Additionally, or alternatively, the described techniques may provide for the network entity 105 to determine the final MCS for application by the UE 115 and indicate the MCS to the UE 115.

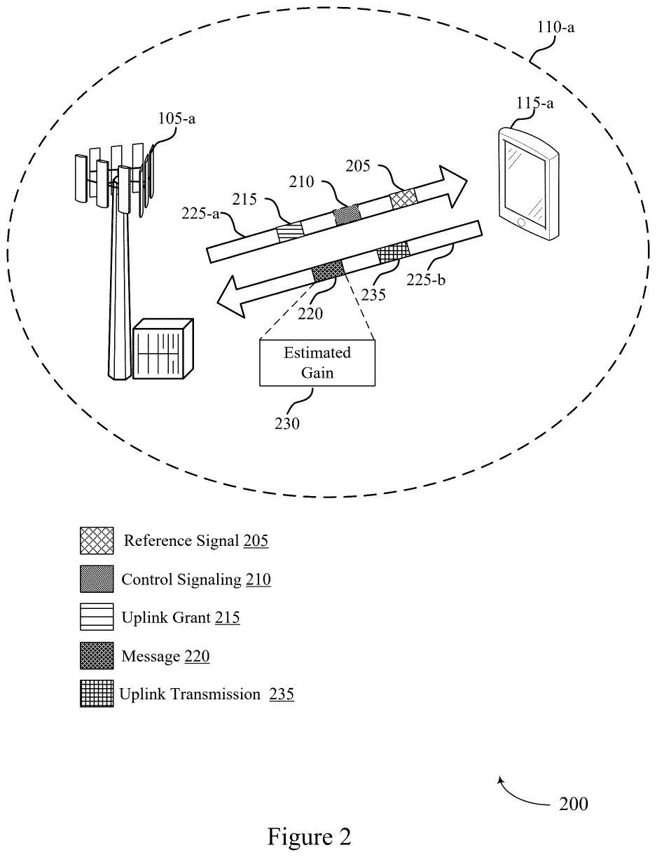

FIG. 2 shows an example of a signaling configuration 200 that supports estimated gain reporting for precoding scheme indication in a wireless communication system in accordance with one or more aspects of the present disclosure. The signaling configuration 200 may implement or be implemented by aspects of the wireless communication system 100 as described herein with reference to FIG. 1. For example, the signaling configuration 200 may be implemented by a network entity 105-a and a UE 115-a, which may represent examples of a network entity 105 and a UE 115, or some other devices, as described herein with reference to FIG. 1. The network entity 105-a may communicate with the UE 115-a within a geographic coverage area 110-a and via a downlink communication link 225-a and an uplink communication link 225-b (e.g., a Uu link). In this example, the network entity 105-a may transmit an uplink grant 215 via the downlink communication link 225-a that indicates a precoding scheme to be applied to an uplink transmission 235 at the UE 115-a. The UE 115-a may transmit, via the uplink communication link 225-b, the uplink transmission 235 (e.g., PUSCH) using the precoding scheme indicated via the uplink grant 215.

As described herein with reference to FIG. 1, some wireless communication systems may apply codebook-based precoding, in which the UE 115-a may receive the uplink grant 215 that indicates the precoding scheme and a MCS to be applied to the uplink transmission 235, where the precoding scheme is selected by the network entity 105-a from a defined codebook (e.g., while operating according to a codebook-based MIMO mode). For example, the UE 115-a may transmit a reference signal (e.g., SRS) to the network entity 105-a, and the network entity 105-a may measure the reference signal and select an MCS and an appropriate precoding scheme from the defined codebook to be applied by the UE 115-a to the uplink transmission 235.

As described herein with reference to FIG. 1, some wireless communication systems may additionally, or alternatively, apply non-codebook-based precoding, in which the precoding scheme may be determined by the UE 115-a without the use of the defined codebook. In such cases, the UE 115-a may measure a reference signal (e.g., CSI-RS) transmitted by the network entity 105-a and may determine the precoding scheme to be applied to a subsequent uplink transmission 235. The UE 115-a may indicate the precoding scheme to the network entity 105-a (e.g., via a pre-coded SRS) and the network entity 105-a may determine the MCS to be applied to the uplink transmission 235. The UE 115-a may receive the uplink grant 215 indicating the MCS, and the UE 115-a may apply the precoding scheme (e.g., UE determined precoding scheme) along with the MCS to the uplink transmission 235. Such precoding techniques may enable higher resolution precoding relative to codebook-based precoding, but may be associated with increased latency due to additional signaling steps and increased processing complexity relative to codebook-based precoding.

Accordingly, some wireless communication systems may support UE-centric MIMO to achieve increased precoding resolution while reducing latency and signal processing complexity. For example, while operating according to a UE-centric MIMO mode, the network entity 105-a may determine a reference MCS while the UE 115-a may determine (e.g., simultaneously) the precoding scheme to be applied to the uplink transmission 235. The UE 115-a may receive the uplink grant 215 indicating the reference MCS and may determine (e.g., calculate) a final MCS to be applied to the uplink transmission 235, along with the precoding scheme. The UE 115-a may transmit the uplink transmission 235 by applying the precoding scheme and the final MCS determined by the UE 115-a. However, in some cases, it may be desirable for the network entity 105-a to determine (e.g., dynamically) whether the UE 115-a applies UE-centric precoding or an alternative precoding technique. Additionally, or alternatively, it may be beneficial for the network entity 105-a to determine the final MCS to be used by the UE 115-a, regardless of the applied precoding technique.

Accordingly, aspects of the subject matter described in this disclosure relate to a flexible UE-centric precoding scheme that enables the UE 115-a to apply either UE-centric precoding or codebook-based precoding to subsequent uplink transmissions 235 based on an estimated gain 230 (e.g., a signal-to-noise ratio (SNR) gain, a MCS gain, and the like) associated with the UE-centric precoding. The described techniques may thereby provide for the UE 115-a and the network entity 105-a to account for tradeoffs in performance gain between UE-centric precoding (e.g., non-codebook-based precoding) and codebook-based precoding. Additionally, or alternatively, the described techniques may provide for the network entity 105-a to determine the final MCS for application by the UE 115-a and indicate the MCS to the UE 115-a.

To perform the flexible UE-centric precoding scheme described herein, the UE 115-a may receive one or more reference signals 205 (e.g., CSI-RSs) from the network entity 105-a and may determine the estimated gain 230 based on measurements of the one or more reference signals 205 and a reference point. The UE 115-a may determine (e.g., calculate) an uplink channel matrix, H, as well as a UE-centric precoding matrix, P_{UE-centric}, based on the measurements of the one or more reference signals 205. Using a given reference power level, Pₓ, the UE 115-a may determine the estimated gain 230, Gain_{dB}, in accordance with Equation 1.

$${Gain}_{dB} = 10 log ( {‖ {HP}_{UE - centric} ‖}_{F}^{2} / {P}_{x} ) \qquad ( 1 )$$

In some cases, the reference power level, Pₓ, may be signaled to the UE 115-a by the network entity 105-a. For example, the network entity may transmit control signaling 210 (e.g., RRC, MAC-CE, DCI, or the like) that indicates the reference power level, Pₓ. In such cases, the UE 115-a may calculate the estimated gain 230, Gain_{dB}, to determine a performance increase associated with applying UE-centric precoding according to the uplink channel matrix, H, and the UE-centric precoding matrix, P_{UE-centric}, compared to the reference power level, Pₓ. In such cases, when the reference power level, Pₓ, is signaled by the network entity 105-a, the estimated gain 230, Gain_{dB}, may be expressed in accordance with Equation 1. In some cases, the estimated gain 230 may be either a SNR gain or a MCS gain.

In some other cases, the reference point used by the UE 115-a to determine the estimated gain 230, Gain_{dB}, may be a reference precoding matrix, P_{ref}, included in a codebook associated with communications between the UE 115-a and the network entity 105-a. In such cases, the UE 115-a may calculate the estimated gain 230, Gain_{dB}, to determine a power gain associated with the use of UE-centric precoding compared to codebook-based precoding using the reference precoding matrix, P_{ref}. In some cases, the reference precoding matrix, P_{ref}, used to calculate the estimated gain 230 may be indicated by the network entity 105-a (e.g., via the control signaling 210) or otherwise defined or configured at the UE 115-a and the network entity 105-a (e.g., defined in a standard). The network entity 105-a may indicate an index value of the reference precoding matrix, P_{ref}, from the codebook associated with communications between the UE 115-a and the network entity 105-a. The reference precoding matrix, P_{ref}, may be indicated based on a rank supported by the UE 115-a, where the UE 115-a may determine the estimated gain 230, Gain_{dB}, for one or more supported ranks.

In some examples, (e.g., for aperiodic gain reporting), the reference precoding matrix P_{ref} may be indicated by the network entity 105-a via a first uplink grant (e.g., by a TPMI field included in the first uplink grant), where the first uplink grant may also schedule the message 220 that indicates the estimated gain. In such cases, the UE 115-a may determine the estimated gain 230, Gain_{dB}, according to a rank of the precoding matrix P_{ref} indicated via the first uplink grant. In some other cases (e.g., for periodic, aperiodic, or semi-persistent gain reporting), the reference precoding matrix, P_{ref}, may be a default (e.g., fixed) precoding matrix used to determine the estimated gain 230, Gain_{dB}, where the reference precoding matrix, P_{ref}, may have an index value associated with one or more ranks supported by the UE 115-a. For example, the reference precoding matrix, P_{ref}, may have an index value that is the lowest index value included in the codebook for a particular rank supported by the UE 115-a, among other examples.

Accordingly, the UE 115-a may determine the reference power level, Pₓ, based on the reference precoding matrix, P_{ref}, and the uplink channel matrix, H, in accordance with Equation 2.

$${P}_{x} = {‖ {HP}_{r e f} ‖}_{F}^{2} \qquad ( 2 )$$

The UE 115-a may use the reference power level, Pₓ, as determined according to Equation 2, to determine the estimated gain 230, Gain_{dB}. For example, the estimated gain 230, Gain_{dB}, may be expressed according to Equation 3, which may combine Equations 1 and 2.

$${Gain}_{dB} = 10 log ( {‖ {HP}_{UE - centric} ‖}_{F}^{2} / {‖ {HP}_{r e f} ‖}_{F}^{2} ) \qquad ( 3 )$$

Thus, the estimated gain 230, Gain_{dB}, may indicate a power gain associated with performing UE-centric precoding compared to codebook-based precoding using the reference precoding matrix, P_{ref}.

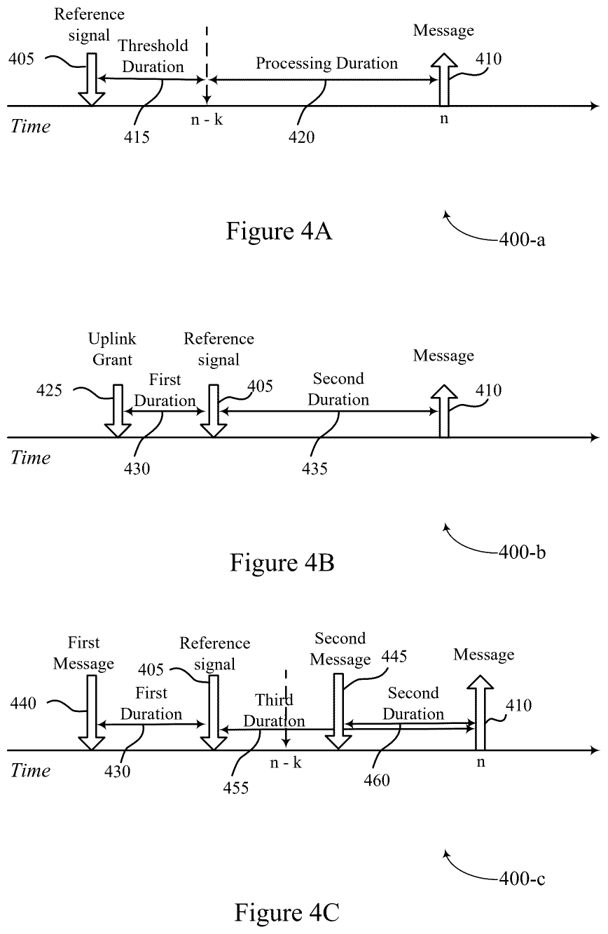

The UE 115-a may transmit a message 220 to the network entity 105-a that indicates the estimated gain 230, Gain_{dB}, associated with the use of UE-centric precoding relative to codebook-based precoding. The network entity 105-a may use the indicated gain 230 to determine a precoding scheme to be applied by the UE 115-a. The UE 115-a may transmit the message 220 based on a capability of the UE 115-a to perform gain reporting, which is described in further detail in FIG. 4A and elsewhere herein. For example, the UE 115-a may transmit the message 220 at a time that is based on a processing duration associated with capabilities of the UE 115-a and associated with performing the gain reporting.

The network entity 105-a may transmit an uplink grant 215 that indicates the precoding scheme to be applied by the UE 115-a in response to the message 220. For example, the network entity 105-a may indicate that the UE 115-a is to apply UE-centric precoding if the estimated gain 230 indicates that UE-centric precoding is associated with improved performance compared to codebook-based precoding, or vice versa.

In some cases, the network entity 105-a may indicate the precoding scheme via a bit included in the uplink grant 215, where a value of the bit indicates whether the UE 115-a is to apply UE-centric precoding or codebook-based precoding to the uplink transmission 235. For example, a first value of the bit may indicate that the UE 115-a is to apply UE-centric precoding to the subsequent uplink transmission 235, and a second value of the bit may indicate that the UE 115-a is to apply codebook-based precoding to the subsequent uplink transmission 235 according to a precoding matrix (e.g., the reference precoding matrix P_{ref}) indicated via an index value. In other cases, the network entity 105-a may indicate the precoding scheme for the subsequent uplink transmission 235 via a field (e.g., a DCI field) of the uplink grant 215. For example, a first set of states of the field may indicate that the UE 115-a is to apply UE-centric precoding to the uplink transmission 235, and a second set of states of the field may indicate that the UE 115-a is to apply codebook-based precoding to the uplink transmission 235.

Additionally, or alternatively, the uplink grant 215 may include a TPMI that indicates a quantity of layers associated with the uplink transmission 235, and the UE 115-a may apply the indicated (e.g., via the bit or the field) precoding scheme according to the quantity of layers indicated via the uplink grant 215. The uplink grant 215 may additionally, or alternatively, indicate the MCS to be applied to the uplink transmission 235, as determined by the network entity 105-a. Accordingly, the UE may transmit the uplink transmission 235 using the precoding scheme and MCS indicated by the network entity 105-a via the uplink grant 215.

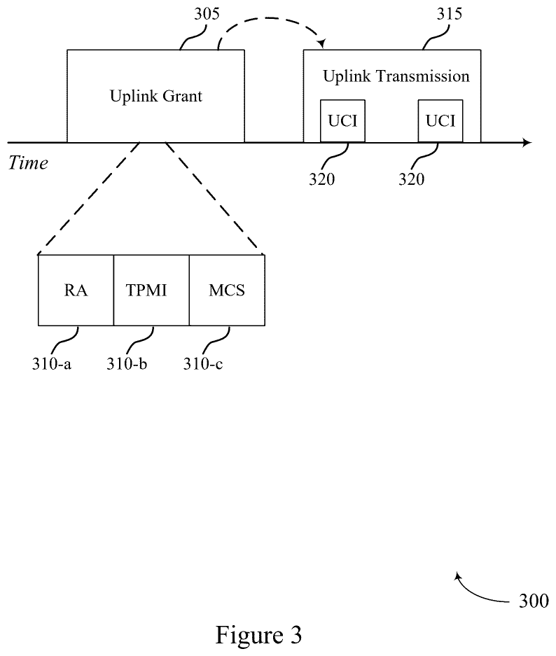

FIG. 3 shows an example of a signaling timeline 300 that supports estimated gain reporting for precoding scheme indication in a wireless communication system. In some cases, the signaling timeline 300 may be implemented by aspects of the wireless communication system 100, the signaling configuration 200, or both. For example, one or more UEs 115, one or more network entities 105, or both may communicate according to the signaling timeline 300.

In some examples, a UE may perform the estimated gain reporting according to an aperiodic reporting scheme. For example, the UE may receive, aperiodically, an uplink grant 305 that indicates the precoding scheme to be applied to an associated uplink transmission 315 as well as resources for transmitting the uplink transmission 315. That is, the network entity may aperiodically schedule uplink transmissions and indicate precoding schemes for each uplink transmission 315. The uplink grant may further include one or more fields 310, such as a resource allocation (RA) field 310-a, a TPMI field 310-b, and an MCS field 310-c, among other examples and field types. In some cases, the UE may perform the gain estimation using a reference precoding matrix (e.g., P_{ref} as described herein with reference to FIG. 2) for a rank indicated via the TPMI field 310-b of the uplink grant 305. For example, the TPMI field 310-b may indicate the reference precoding matrix and the rank for the uplink transmission 315, and the UE may perform the gain estimation for the rank of the uplink transmission 315 indicated via the TPMI field 310-b. The network entity may additionally, or alternatively, indicate, via the MCS field 310-c in the uplink grant 305, an MCS to be applied to the uplink transmission 315. The MCS may be determined by the network entity based on measurements of reference signals transmitted by the UE. The network entity may further indicate the precoding scheme to be applied to the uplink transmission 315 via the uplink grant 305. For example, the network entity may indicate that the UE is to apply UE-centric precoding rather than codebook-based precoding to the uplink transmission 315, where UE-centric precoding may be enabled at the UE based on receiving the uplink grant 305. Accordingly, the UE may transmit the uplink transmission 315 by applying the precoding scheme and the MCS indicated via the uplink grant 305.

In some examples, the UE may have previously transmitted a message (e.g., not shown in FIG. 3) that indicates the estimated gain, and the network entity may select the precoding scheme to be applied by the UE based on the estimated gain indicated in the previously transmitted message. Additionally, or alternatively, FIG. 3 may, in some examples, illustrate the UE transmitting an indication of the estimated gain by piggybacking the indication in the uplink transmission 315. For example, the UE may transmit a scheduled message via a PUSCH and may piggyback or otherwise append uplink control information (UCI) 320 (e.g., either prefixed to the uplink transmission 315 or embedded in the uplink transmission 315, as shown in FIG. 3) that indicates the estimated gain. In some cases, the UCI 320 may be included in the uplink transmission 315 based on the UE applying UE-centric precoding to the uplink transmission 315, where the UCI may indicate the estimated gain in terms of a SNR gain, a MCS gain, a SNR, a MCS, or any combination thereof. The network entity may use the indication of the estimated gain to select a precoding scheme, a MCS, or both to be applied by the UE to future uplink transmissions. Thus, based on the estimated gain, the network entity may indicate whether the UE is to apply UE-centric precoding or codebook-based precoding to subsequent uplink transmissions via subsequent uplink grants. As such, in some cases, the UE may apply the precoding scheme, the MCS, or both to a subsequent transmission on the PUSCH based on receiving a subsequent uplink grant.

FIGS. 4A-4C show examples of signaling timelines 400 that support estimated gain reporting for precoding scheme indication in a wireless communication system. In some cases, the signaling timelines 400-a, 400-b, and 400-c may be implemented by or may otherwise implement aspects of the wireless communication system 100, the signaling configuration 200, the signaling timeline 300, or any combination thereof. For example, one or more UEs 115, one or more network entities 105, or both may communicate according to the signaling timelines 400-a, 400-b, and 400-c.

As described herein and with reference to FIG. 2, a UE may transmit a message 410 that indicates an estimated gain associated with the use of UE-centric precoding compared to codebook-based precoding for communications between the UE and a network entity. The estimated gain may be based on measurements of one or more reference signals 405, where the UE may receive the one or more reference signals 405 via configured resources, via resources allocated by an uplink grant, or via resources indicated by other control signaling. Additionally, or alternatively, various techniques (e.g., configurations, periodicities) may be implemented to initiate the estimated gain reporting at the UE as described herein. For example, the UE may perform the estimated gain reporting according to one or more reporting schemes (e.g., periodic, semi-persistent, aperiodic).

FIG. 4A shows a first example signaling timeline 400-a in accordance with periodic or semi-persistent estimated gain reporting at the UE, where the UE may transmit the message 410 via resources configured by the network entity periodically or semi-persistently based on a capability of the UE to perform the estimated gain reporting. For example, the UE may support a processing duration 420 associated with performing the gain estimation (e.g., a maximum duration for the UE to process a received signal and perform the gain estimation). The UE may transmit the message 410 at a time (e.g., slot index), n, which may be indicated via previous scheduling information for the UE (e.g., or otherwise a configured transmission occasion for the UE). For example, the network entity may configure periodic resources or semi-persistent resources via which the UE is to transmit the message 410 that indicates the estimated gain, where n may be a time at which one of the periodic resources or semi-persistent resources is scheduled. The UE may therefore determine a reference timing for transmitting the message 410 based on the time n and the processing duration 420. For example, the UE may derive a reference time n-k by incrementing backwards from the time n by the processing duration 420, k. The UE may determine which reference signal to measure based on the reference time n-k. For example, the UE may measure the reference signal 405, which may be the most recently received reference signal before the reference time n-k. For example, the reference signal 405 may be received a threshold duration 415 before the reference time n-k. The UE may receive no additional reference signals following the reference signal 405 within the threshold duration 415 and may therefore use the reference signal 405 to perform the gain estimation. Thus, the UE may determine which reference signal is to be used to perform the gain estimation based on the processing duration 420 and the time n configured for the UE.

FIG. 4B shows a second example of a signaling timeline 400-b that supports estimated gain reporting according to an aperiodic reporting scheme via allocated resources. For example, the network entity may transmit an uplink grant to schedule each message 410 to be sent by the UE. The scheduling may thereby be aperiodic. In this example, the UE may receive an uplink grant 425 (e.g., a first uplink grant), which may indicate (e.g., allocate) first resources for transmission, by the network entity, of the reference signal 405 to be measured for the estimated gain reporting as well as second resources for transmission, by the UE, of the message 410.

The UE may receive the reference signal 405 via the first resources indicated via the uplink grant 425 and may perform the gain estimation based on measurements of the reference signal 405. The UE may then transmit the message 410 indicating the estimated gain via the second recourses indicated via the uplink grant. For example, as shown by FIG. 4, the uplink grant 425 may indicate that the reference signal 405 to be used for the gain reporting is to be received a first duration 430 (e.g., quantity of slots or a quantity of symbols) following the uplink grant 425. The uplink grant may further indicate that the message 410 is to be transmitted via the second resources, following a second duration 435 after receiving the reference signal 405. In some cases, the duration 435 between receiving the reference signal 405 and transmitting the message 410 may be associated with a capability of the UE, where the duration 435 may be based on (e.g., greater than or equal to) the processing duration 420 as described herein with reference to FIG. 4A. As such, the UE may perform the estimated gain reporting according to the aperiodic reporting scheme using resources indicated via the uplink grant 425.

FIG. 4C shows a third example of a signaling timeline 400-c that supports estimated gain reporting according to an aperiodic reporting scheme via allocated resources. For example, the network entity may transmit a first message to schedule each reference signal 405 to be received by the UE. The network entity may additionally transmit a second message that schedules each message 410 to be transmitted by the UE. The scheduling may thereby be aperiodic. In this example, the UE may receive a first message 440 (e.g., a first uplink grant), which may indicate (e.g., allocate) first resources for receiving, by the network entity, the reference signal 405 to be measured for the estimated gain reporting. The UE may additionally (e.g., in the case of decoupled-triggering) receive a second message 445 which may indicate second resources for transmitting the message 410 indicating the estimated gain.

The UE may receive the reference signal 405 via the first resources indicated by the first message 440 (e.g., which may be an uplink grant or other control signaling) that indicates first resources associated with reference signal 405. For example, the UE may receive the reference signal 405 via the first resources, which may be a first duration 430 after receiving the first message 440. The UE may determine the estimated gain using the reference signal 405, and the UE may transmit the message 410 via the second resources indicated by the second message 445. The UE may transmit the message 410 at a time n, which may be a time at which the second resources are configured for the UE. For example, the UE may transmit the message 410 via the second resources at the time n, which may be a second duration 460 after receiving the second message 445.

In some cases, a third duration 455 spanning between the time at which the reference signal is received and the time n at which the message 410 is transmitted may be greater than or equal to a processing duration (e.g., the processing duration 420 as described herein with reference to FIG. 4A) associated with performing gain reporting at the UE. For example, the UE may be capable of performing the gain reporting using reference signals 405 received prior to a reference time n-k (e.g., the reference time n-k as described herein with reference to FIG. 4A) to account for the processing duration supported by the UE. Thus, the first message 440 and the second message 410 may indicate (e.g., schedule) the first and second resources for the gain estimation and estimated gain reporting based on a capability of the UE to perform the gain reporting.

Performing the estimated gain reporting at the UE according to a periodic, semi-persistent, or aperiodic reporting scheme, as shown in FIGS. 4A-4C, may enable higher resolution precoding at the UE with decreased latency, while the network entity may indicate the final MCS and precoding scheme to be applied by the UE for subsequent uplink transmissions. As described herein, the UE may report the estimated gain to the network entity so that the network entity may determine the precoding scheme to be applied by the UE to subsequent uplink transmissions. Thus, the network entity may indicate to the UE (e.g., dynamically) a precoding scheme and an MCS to be applied to subsequent uplink transmissions in cases where UE-centric precoding is enabled.

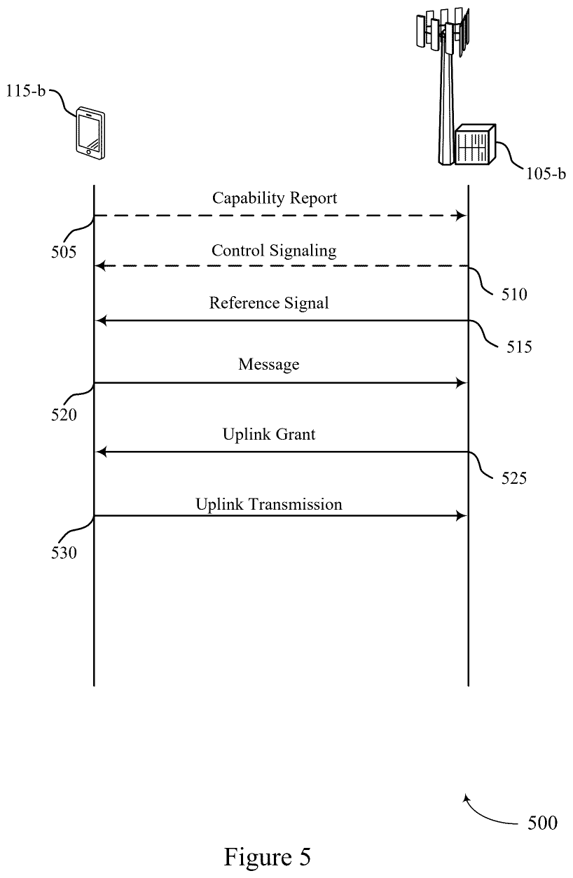

FIG. 5 shows an example of a process flow 500 that supports estimated gain reporting for precoding scheme indication in a wireless communication system in accordance with one or more aspects of the present disclosure. The process flow 500 may implement aspects of or may be implemented by aspects of the wireless communication system 100 or the signaling configuration 200. For example, the process flow 500 may include a UE 115-b and a network entity 105-b, which may be examples of the corresponding devices as described herein with reference to FIG. 1.

In the following description of the process flow 500, the operations between the UE 115-b and the network entity 105-b may be communicated in a different order than the example order shown, or the operations performed by the UE 115-b and the network entity 105-b may be performed in different orders or at different times. Some operations may also be omitted from the process flow 500, and other operations may be added to the process flow 500.

At 505, in some examples, the UE 115-b may transmit, to the network entity 105-b, a capability report that indicates a capability of the UE 115-b to perform gain reporting. For example, the capability report may indicate a processing duration associated with the gain reporting by the UE 115-b, where a time at which the UE 115-b transmits a message indicating the estimated gain is based on the processing duration.

At 510, in some examples, the network entity 105-b may transmit, to the UE 115-b, control signaling that indicates a reference point for determining the estimated gain, resources for performing the estimated gain reporting, a rank or a set of ranks for which the UE 115-b is to calculate the estimated gain, or any combination thereof. For example, the control signaling may indicate a reference power level or a reference precoding matrix (e.g., the reference power level, Pₓ, or the reference precoding matrix, P_{ref}, described in FIG. 2) that may be used by the UE 115-b to determine the estimated gain. Additionally, or alternatively, the control signaling may allocate one or more transmission occasions for periodic or semi-persistent gain reporting, where the UE 115-b may transmit the message that indicates the estimated gain via at least one transmission occasion allocated by the control signaling, as shown in FIGS. 4A-4C and described elsewhere herein. The estimated gain may be calculated for the rank indicated by the control signaling, or may be calculated for each rank of the set of ranks indicated by the control signaling.

At 515, the network entity 105-b may transmit a reference signal to the UE 115-b. The UE 115-b may support a processing duration and may measure the reference signal based on receiving the reference signal at a time that accounts for the processing duration supported by the UE 115-b. In some examples, the UE 115-b may measure the reference signal based on the reference signal being the most recently received reference signal prior to a reference time supported by the UE 115-b, as described in further detail elsewhere herein, including with reference to FIG. 4A. Accordingly, the UE 115-b may determine the estimated gain based on measurements of the reference signal received at 515.

At 520, the UE 115-b may transmit, to the network entity 105-b, a message that indicates the estimated gain associated with the use of UE-centric precoding relative to codebook-based precoding for communications by the UE 115-b. The UE 115-b may transmit the message via at least one transmission occasion allocated via the control signaling, or via resources indicated via a first uplink grant. In some cases, the UE 115-b may transmit the message at a time based on the processing duration associated with gain reporting at the UE 115-b indicated via the capability report. In some examples, the message may convey the estimated gain directly. Additionally, or alternatively, the message may be an uplink transmission (e.g., PUSCH), and the UE 115-b may piggyback UCI or other control information to the uplink transmission to indicate the estimated gain, as described in further detail elsewhere herein, including with reference to FIG. 3.

At 525, the network entity may transmit an uplink grant that indicates a precoding scheme to be applied by the UE 115-b for a subsequent uplink transmission. For example, based on the estimated gain indicated via the message, the network entity may determine that the UE 115-b is to apply UE-centric precoding or codebook-based precoding to the subsequent uplink transmission. The network entity may indicate the selected precoding scheme via a value of a bit included in the uplink grant or via one or more states of a field included in the uplink grant.

At 530, the UE 115-b may transmit the uplink transmission using the precoding scheme indicated via the uplink grant. For example, the UE 115-b may transmit the uplink transmission using UE-centric precoding if the estimated gain indicates that UE-centric precoding is associated with greater performance than codebook-based precoding for subsequent uplink transmissions by the UE 115-b. The UE 115-b may transmit the uplink transmission via resources indicated by the control signaling received at 510, via resources indicated by a first uplink grant, or via resources indicated via the uplink grant received at 525.

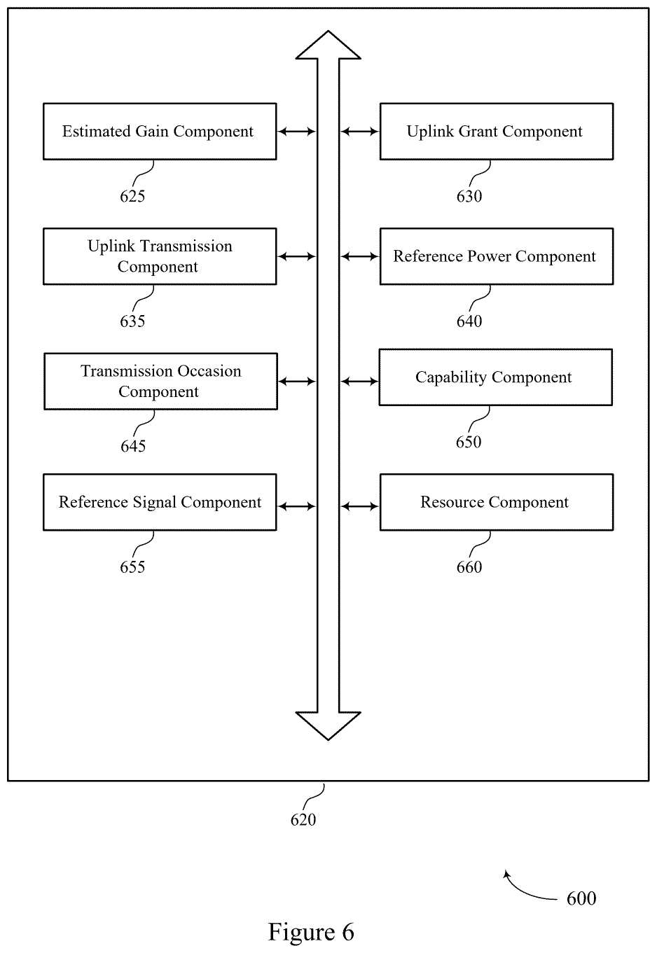

FIG. 6 shows an example of a processing system 620 that supports estimated gain reporting for precoding scheme indication in a wireless communication system. A processing system 620 may be an example of a processing system 140 (such as of a UE 115) and may include an estimated gain component 625, an uplink grant component 630, an uplink transmission component 635, a reference power component 640, a transmission occasion component 645, a capability component 650, a reference signal component 655, a resource component 660, or any combination thereof. A processing system 620, or various component thereof, may be an example of means for performing (such as a means for causing a UE 115 to perform) various techniques described herein.

The estimated gain component 625 may be configured to cause the UE 115 to transmit a message that indicates an estimated gain associated with use of UE-centric precoding for communications by the UE, where the estimated gain is based on measurement of a reference signal. The uplink grant component 630 may be configured to cause the UE 115 to receive an uplink grant that indicates a precoding scheme for a subsequent uplink transmission, the precoding scheme including the UE-centric precoding or codebook-based precoding based on the estimated gain. The uplink transmission component 635 may be configured to cause the UE 115 to transmit, based on the uplink grant and using the precoding scheme indicated via the uplink grant, the subsequent uplink transmission.

In some examples, the reference power component 640 may be configured to cause the UE 115 to receive a second message that indicates a reference power level associated with the communications by the UE, where the estimated gain includes an estimated power gain associated with the use of the UE-centric precoding for the communications relative to the reference power level.

In some examples, to support transmitting the message, the estimated gain component 625 may be configured to cause the UE 115 to transmit, via the message, an indication of the estimated gain including an estimated performance gain associated with the use of the UE-centric precoding for the communications relative to an estimated performance associated with use of the codebook-based precoding for the communications, where the estimated performance associated with the codebook-based precoding is based on a reference precoding matrix.

In some examples, the reference precoding matrix is indicated via control signaling or is based on a value of an index of the reference precoding matrix.

In some examples, the uplink grant component 630 may be configured to cause the UE 115 to receive a first uplink grant that schedules the message and that indicates the reference precoding matrix.

In some examples, the transmission occasion component 645 may be configured to cause the UE 115 to receive control signaling that allocates a set of multiple transmission occasions for periodic or semi-persistent gain reporting for one or more ranks, where the message that indicates the estimated gain is transmitted via at least one transmission occasion of the set of multiple transmission occasions allocated via the control signaling, and where the estimated gain is associated with the one or more ranks.

In some examples, the capability component 650 may be configured to cause the UE 115 to transmit a capability report that indicates a capability of the UE to perform gain reporting and indicates a processing duration associated with the gain reporting by the UE, where a time at which the UE transmits the message is based on the processing duration.

In some examples, the reference signal component 655 may be configured to cause the UE 115 to receive the reference signal at a first time, where the estimated gain is based on the measurement of the reference signal and based on the first time at which the reference signal is received being at least a threshold duration before the time for transmission of the message, the threshold duration based on the processing duration of the UE.

In some examples, the uplink grant component 630 may be configured to cause the UE 115 to receive a first uplink grant that indicates first resources associated with the reference signal and second resources associated with the message. In some examples, the reference signal component 655 may be configured to cause the UE 115 to receive the reference signal via the first resources indicated via the first uplink grant, where the estimated gain is based on measurements of the reference signal received via the first resources, and where the message is transmitted via the second resources indicated via the first uplink grant.

In some examples, the resource component 660 may be configured to cause the UE 115 to receive a first message that indicates first resources associated with the reference signal. In some examples, the reference signal component 655 may be configured to cause the UE 115 to receive the reference signal via the first resources indicated via the first message. In some examples, the resource component 660 may be configured to cause the UE 115 to receive a second message that indicates second resources associated with the message, where the message is transmitted via the second resources indicated via the second message.

In some examples, to support receiving the uplink grant, the uplink grant component 630 may be configured to cause the UE 115 to receive, via the uplink grant, a precoding matrix indicator that indicates a quantity of layers associated with the subsequent uplink transmission and a bit that indicates the precoding scheme for the subsequent uplink transmission, where a first value of the bit indicates the precoding scheme includes the UE-centric precoding and a second value of the bit indicates the precoding scheme includes the codebook-based precoding.

In some examples, to support receiving the uplink grant, the uplink grant component 630 may be configured to cause the UE 115 to receive, via the uplink grant, a field that indicates a quantity of layers associated with the subsequent uplink transmission and that indicates the precoding scheme for the subsequent uplink transmission, where a first set of states of the field indicate the precoding scheme includes the UE-centric precoding and a second set of states of the field indicate the precoding scheme includes the codebook-based precoding.

In some examples, the estimated gain is an estimated signal-to-noise ratio gain or an estimated MCS gain.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described herein with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for higher resolution precoding with reduced latency.

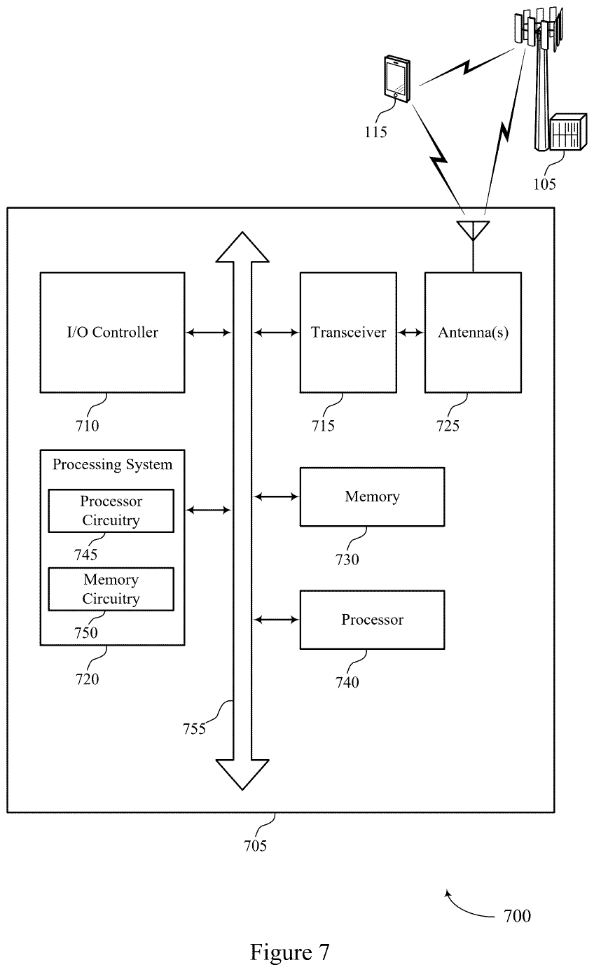

FIG. 7 shows an example of a system 700 including a device 705 that supports estimated gain reporting for precoding scheme indication in a wireless communication system. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support estimated gain reporting for precoding scheme indication in a wireless communication system. Although the processing system 720 is illustrated as a separate component, which may involve a separate chip, chipset, or other module, in some implementations, one or more functions described herein with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for higher resolution precoding with reduced latency.

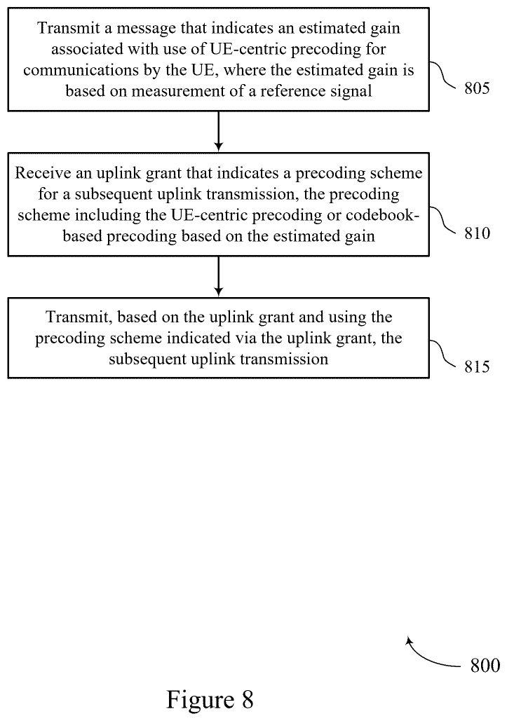

FIG. 8 shows an example of a method 800 that supports estimated gain reporting for precoding scheme indication in a wireless communication system. Operations of the method 800 may be performed by a UE or its components (such as using a processing system configured to cause the UE 115 to perform one or more of the operations) as described herein.

At 805, the method may include transmitting a message that indicates an estimated gain associated with use of UE-centric precoding for communications by the UE, where the estimated gain is based on measurement of a reference signal. In some examples, aspects of the operations of 805 may be performed by an estimated gain component 625.

At 810, the method may include receiving an uplink grant that indicates a precoding scheme for a subsequent uplink transmission, the precoding scheme including the UE-centric precoding or codebook-based precoding based on the estimated gain. In some examples, aspects of the operations of 810 may be performed by an uplink grant component 630.

At 815, the method may include transmitting, based on the uplink grant and using the precoding scheme indicated via the uplink grant, the subsequent uplink transmission. In some examples, aspects of the operations of 815 may be performed by an uplink transmission component 635.

Implementation examples are described in the following numbered clauses:

Aspect 1: A method for wireless communications at a UE, comprising: receiving, while operating according to a first mode of the UE, a wake-up signal, wherein the first mode is associated with a lower power consumption than a second mode of the UE; transmitting, based at least in part on the wake-up signal, a message that requests verification information associated with the wake-up signal, wherein a time at which the message is transmitted is based at least in part on a threshold duration after receipt of the wake-up signal; and receiving, based at least in part on the message, the verification information that indicates whether the wake-up signal is a valid wake-up signal, or whether a downlink transmission to the UE is scheduled, or both, wherein the UE operates according to the first mode or the second mode based at least in part on the verification information associated with the wake-up signal.

Aspect 2: The method of aspect 1, further comprising: transitioning from the first mode to the second mode for the threshold duration after the receipt of the wake-up signal, wherein the message is transmitted during the threshold duration while operating according to the second mode; and transitioning from the second mode to the first mode after receipt of the verification information based at least in part on the verification information indicating that the wake-up signal is an invalid wake-up signal.

Aspect 3: The method of aspect 1, further comprising: transitioning from the first mode to the second mode for the threshold duration after the receipt of the wake-up signal, wherein the message is transmitted during the threshold duration while operating according to the second mode; and operating according to the second mode after receipt of the verification information based at least in part on the verification information indicating that the wake-up signal is the valid wake-up signal.

Aspect 4: The method of any of aspects 1 through 3, further comprising: monitoring, during the threshold duration and while operating in the second mode, for the downlink transmission, wherein the UE transitions from the first mode to the second mode based at least in part on the wake-up signal, and wherein transmitting the message is based at least in part on an absence of the downlink transmission during the threshold duration.

Aspect 5: The method of aspect 4, wherein the verification information indicates whether the wake-up signal is the valid wake-up signal or not, the method further comprising: transitioning from the second mode to the first mode based at least in part on the verification information indicating that the wake-up signal is not the valid wake-up signal; or operating in the second mode for a second duration based at least in part on the verification information indicating that the wake-up signal is the valid wake-up signal.

Aspect 6: The method of any of aspects 4 through 5, wherein the verification information indicates whether the downlink transmission to the UE is scheduled or not, the method further comprising: transitioning from the second mode to the first mode based at least in part on the verification information indicating that the downlink transmission is not scheduled; or monitoring, according to the second mode for a second duration, for the downlink transmission based at least in part on the verification information indicating that the downlink transmission is scheduled.

Aspect 7: The method of any of aspects 4 through 6, further comprising: wherein the threshold duration comprises a quantity of paging monitoring occasions after the receipt of the wake-up signal.

Aspect 8: The method of any of aspects 1 through 7, further comprising: transmitting a capability report that indicates a battery capability of the UE, wherein the threshold duration is based at least in part on the battery capability of the UE.

Aspect 9: The method of any of aspects 1 through 10, further comprising: receiving a plurality of wake-up signals comprising at least the wake-up signal, wherein transmitting the message is based at least in part on at least a threshold quantity of wake-up signals included in the plurality of wake-up signals being correlated.

Aspect 11: The method of any of aspects 1 through 9, wherein the first mode is associated with operations in an inactive state of a connected mode discontinuous reception cycle, and the second mode is associated with operations in an active state of the connected mode discontinuous reception cycle.

Aspect 12: The method of any of aspects 1 through 9, wherein the first mode is associated with sparse search space set group monitoring by the UE, and the second mode is associated with dense search space set group monitoring by the UE.

Aspect 13: The method of any of aspects 1 through 12, further comprising: receiving control signaling that indicates the threshold duration.

Aspect 14: A method for wireless communications at a UE, comprising: receiving, while operating according to a first mode of the UE, a wake-up signal, wherein the first mode is associated with a lower power consumption than a second mode of the UE; monitoring, while operating according to the second mode of the UE during a threshold duration after receipt of the wake-up signal, for a downlink transmission based at least in part on the wake-up signal; and operating according to the first mode or the second mode based at least in part on a whether the downlink transmission is received during the threshold duration.

Aspect 15: The method of aspect 14, wherein operating according to the first mode or the second mode further comprises: operating according to the first mode based at least in part on an absence of the downlink transmission during the threshold duration.

Aspect 16: The method of any of aspect 14, wherein operating according to the first mode or the second mode further comprises: operating according to the second mode based at least in part on receipt of the downlink transmission by the UE during the threshold duration.

Aspect 17: The method of any of aspects 14 through 16, wherein operating according to the first mode or the second mode further comprises: transitioning from the second mode to the first mode after a first portion of the threshold duration based at least in part on an absence of the downlink transmission within the first portion of the threshold duration, wherein the first portion of the threshold duration is based at least in part on a value of a timer at the UE satisfying a threshold, and wherein the UE operates according to the first mode for a remaining portion of the threshold duration.

Aspect 18: The method of any of the aspects 14 through 19, further comprising: receiving a plurality of wake-up signals comprising at least the wake-up signal, wherein monitoring while operating according to the second mode is based at least in part on a quantity of correlated wake-up signals within the plurality of wake-up signals exceeding a threshold quantity.

Aspect 20: A UE for wireless communications, comprising: at least one processor; and memory coupled with the at least one processor, with instructions stored in the at least one memory, the instructions being executable by the at least one processor, individually or in any combination, to cause the UE to perform a method of any of aspects 1 through 13.

Aspect 21: A UE for wireless communications, comprising at least one means for performing a method of any of aspects 1 through 13.

Aspect 22: A non-transitory computer-readable medium storing code for wireless communications, the code comprising instructions executable by one or more processors to perform a method of any of aspects 1 through 13.

Aspect 23: A UE for wireless communications, comprising: at least one processor; and memory coupled with the at least one processor, with instructions stored in the at least one memory, the instructions being executable by the at least one processor, individually or in any combination, to cause the UE to perform a method of any of aspects 14 through 18.

Aspect 24: A UE for wireless communications, comprising at least one means for performing a method of any of aspects 14 through 18.

Aspect 25: A non-transitory computer-readable medium storing code for wireless communications, the code comprising instructions executable by one or more processors to perform a method of any of aspects 14 through 18.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
transmit a message that indicates an estimated gain associated with use of UE-centric precoding for communications by the UE, wherein the estimated gain is based at least in part on measurement of a reference signal;
receive an uplink grant that indicates a precoding scheme for a subsequent uplink transmission, the precoding scheme comprising the UE-centric precoding or codebook-based precoding based at least in part on the estimated gain; and
transmit, based at least in part on the uplink grant and using the precoding scheme indicated via the uplink grant, the subsequent uplink transmission.

2. The UE of claim 1, wherein the instructions are further executable by the at least one processor, individually or in any combination, to cause the UE to:
receive a second message that indicates a reference power level associated with the communications by the UE, wherein the estimated gain comprises an estimated power gain associated with the use of the UE-centric precoding for the communications relative to the reference power level.

3. The UE of claim 1, wherein the instructions to transmit the message are further executable by the at least one processor, individually or in any combination, to cause the UE to:
transmit, via the message, an indication of the estimated gain comprising an estimated performance gain associated with the use of the UE-centric precoding for the communications relative to an estimated performance associated with use of the codebook-based precoding for the communications, wherein the estimated performance associated with the codebook-based precoding is based at least in part on a reference precoding matrix.

4. The UE of claim 3, wherein the reference precoding matrix is indicated via control signaling or is based at least in part on a value of an index of the reference precoding matrix.

5. The UE of claim 3, wherein the instructions are further executable by the at least one processor, individually or in any combination, to cause the UE to:
receive a first uplink grant that schedules the message and that indicates the reference precoding matrix.

6. The UE of claim 1, wherein the instructions are further executable by the at least one processor, individually or in any combination, to cause the UE to:
receive control signaling that allocates a plurality of transmission occasions for periodic or semi-persistent gain reporting for one or more ranks, wherein the message that indicates the estimated gain is transmitted via at least one transmission occasion of the plurality of transmission occasions allocated via the control signaling, and wherein the estimated gain is associated with the one or more ranks.

7. The UE of claim 1, wherein the instructions are further executable by the at least one processor, individually or in any combination, to cause the UE to:
transmit a capability report that indicates a capability of the UE to perform gain reporting and indicates a processing duration associated with the gain reporting by the UE, wherein a time at which the UE transmits the message is based at least in part on the processing duration.

8. The UE of claim 7, wherein the instructions are further executable by the at least one processor, individually or in any combination, to cause the UE to:
receive the reference signal at a first time, wherein the estimated gain is based at least in part on the measurement of the reference signal and based at least in part on the first time at which the reference signal is received being at least a threshold duration before the time for transmission of the message, the threshold duration based at least in part on the processing duration of the UE.

9. The UE of claim 1, wherein the instructions are further executable by the at least one processor, individually or in any combination, to cause the UE to:
receive a first uplink grant that indicates first resources associated with the reference signal and second resources associated with the message; and
receive the reference signal via the first resources indicated via the first uplink grant, wherein the estimated gain is based at least in part on measurements of the reference signal received via the first resources, and wherein the message is transmitted via the second resources indicated via the first uplink grant.

10. The UE of claim 1, wherein the instructions are further executable by the at least one processor, individually or in any combination, to cause the UE to:
receive a first message that indicates first resources associated with the reference signal;
receive the reference signal via the first resources indicated via the first message; and
receive a second message that indicates second resources associated with the message, wherein the message is transmitted via the second resources indicated via the second message.

11. The UE of claim 1, wherein, to receive the uplink grant, the instructions are further executable by the at least one processor, individually or in any combination, to cause the UE to:
receive, via the uplink grant, a precoding matrix indicator that indicates a quantity of layers associated with the subsequent uplink transmission and a bit that indicates the precoding scheme for the subsequent uplink transmission, wherein a first value of the bit indicates the precoding scheme comprises the UE-centric precoding and a second value of the bit indicates the precoding scheme comprises the codebook-based precoding.

12. The UE of claim 1, wherein, to receive the uplink grant, the instructions are further executable by the at least one processor, individually or in any combination, to cause the UE to:
receive, via the uplink grant, a field that indicates a quantity of layers associated with the subsequent uplink transmission and that indicates the precoding scheme for the subsequent uplink transmission, wherein a first set of states of the field indicate the precoding scheme comprises the UE-centric precoding and a second set of states of the field indicate the precoding scheme comprises the codebook-based precoding.

13. The UE of claim 1, wherein the estimated gain is an estimated signal-to-noise ratio gain or an estimated modulation and coding scheme gain.

14. A method for wireless communications at a user equipment (UE), comprising:
transmitting a message that indicates an estimated gain associated with use of UE-centric precoding for communications by the UE, wherein the estimated gain is based at least in part on measurement of a reference signal;
receiving an uplink grant that indicates a precoding scheme for a subsequent uplink transmission, the precoding scheme comprising the UE-centric precoding or codebook-based precoding based at least in part on the estimated gain; and
transmitting, based at least in part on the uplink grant and using the precoding scheme indicated via the uplink grant, the subsequent uplink transmission.

15. The method of claim 14, further comprising:
receiving a second message that indicates a reference power level associated with the communications by the UE, wherein the estimated gain comprises an estimated power gain associated with the use of the UE-centric precoding for the communications relative to the reference power level.

16. The method of claim 14, wherein transmitting the message further comprises:
transmitting, via the message, an indication of the estimated gain comprising an estimated performance gain associated with the use of the UE-centric precoding for the communications relative to an estimated performance associated with use of the codebook-based precoding for the communications, wherein the estimated performance associated with the codebook-based precoding is based at least in part on a reference precoding matrix.

17. The method of claim 16, wherein the reference precoding matrix is indicated via control signaling or is based at least in part on a value of an index of the reference precoding matrix.

18. The method of claim 16, further comprising:
receiving a first uplink grant that schedules the message and that indicates the reference precoding matrix.

19. The method of claim 14, further comprising:
receiving control signaling that allocates a plurality of transmission occasions for periodic or semi-persistent gain reporting for one or more ranks, wherein the message that indicates the estimated gain is transmitted via at least one transmission occasion of the plurality of transmission occasions allocated via the control signaling, and wherein the estimated gain is associated with the one or more ranks.

20. A user equipment (UE) for wireless communications, comprising:
means for transmitting a message that indicates an estimated gain associated with use of UE-centric precoding for communications by the UE, wherein the estimated gain is based at least in part on measurement of a reference signal;
means for receiving an uplink grant that indicates a precoding scheme for a subsequent uplink transmission, the precoding scheme comprising the UE-centric precoding or codebook-based precoding based at least in part on the estimated gain; and
means for transmitting, based at least in part on the uplink grant and using the precoding scheme indicated via the uplink grant, the subsequent uplink transmission.
